(19) United States
(12) Patent Application Publication
(10) Pub. No.: US 2018/0288436 A1
(43) Pub. Date: Oct. 4, 2018

(54) METHODS AND APPARATUS FOR PROVIDING IN-LOOP PADDING TECHNIQUES FOR ROTATED SPHERE PROJECTIONS

(71) Applicant: GoPro, Inc., San Mateo, CA (US)

(72) Inventors: Adeel Abbas, Carlsbad, CA (US); David Newman, San Diego, CA (US)

(21) Appl. No.: 15/719,291

(22) Filed: Sep. 28, 2017

Related U.S. Application Data
(60) Provisional application No. 62/481,013, filed on Apr. 3, 2017.

(51) Int. Cl. H04N 19/597; H04N 19/33; H04N 19/124

(52) U.S. Cl. CPC H04N 19/597; G06T 3/60; H04N 19/124; H04N 19/33

(57) ABSTRACT

Apparatus and methods for providing in-loop padding techniques for projection formats, such as, Rotated Sphere Projections (RSP). In one embodiment, methods and apparatus for the encoding of video data is disclosed, the video data includes a projection format that has redundant data, the apparatus and methods include obtaining a frame of video data, the frame of video data including reduced quality areas within the frame of video data; transmitting the obtained frame of the video data to a reconstruction engine; reconstructing the reduced quality areas to nearly original quality within the frame by using other portions of the frame of video data in order to construct a high fidelity frame of video data; storing the high fidelity frame of video data within a reference picture list; and using the high fidelity frame of video data stored within the reference picture list for encoding of subsequent frames of the video data. Methods and apparatus for the decoding of encoded video data are also disclosed.

### PRIORITY

This application claims the benefit of priority to U.S. Provisional Patent Application Ser. No. 62/481,013 filed Apr. 3, 2017 and entitled “Video Coding Techniques for Rotated Sphere Projections”, the contents of which are incorporated herein by reference in its entirety.

### RELATED APPLICATIONS

This application is related to U.S. patent application Ser. No. 15/665,202 filed Jul. 31, 2017 and entitled “Methods and Apparatus for Providing a Frame Packing Arrangement for Panoramic Content”, which claims the benefit of priority to U.S. Provisional Patent Application Ser. No. 62/477,936 filed Mar. 28, 2017 of the same title; U.S. Provisional Patent Application Ser. No. 62/473,952 filed Mar. 20, 2017 of the same title; U.S. Provisional Patent Application Ser. No. 62/465,678 filed Mar. 1, 2017 of the same title; U.S. Provisional Patent Application Ser. No. 62/462,804 filed Feb. 23, 2017 of the same title; and U.S. Provisional Patent Application Ser. No. 62/446,297 filed Jan. 13, 2017 and entitled “Methods and Apparatus for Rotated Sphere Projections”, each of the foregoing being incorporated herein by reference in its entirety.

This application is also related to U.S. patent application Ser. No. 15/289,851 filed Oct. 10, 2016 and entitled “Apparatus and Methods for the Optimal Stitch Zone Calculation of a Generated Projection of a Spherical Image”, which is incorporated herein by reference in its entirety.

This application is also related to U.S. patent application Ser. No. 15/234,869 filed Aug. 11, 2016 and entitled “Equatorial Stitching of Hemispherical Images in a Spherical Image Capture System”, which claims the benefit of priority to U.S. Provisional Patent Application Ser. No. 62/204,290 filed on Aug. 12, 2015, each of the foregoing being incorporated herein by reference in its entirety.

This application is also related to U.S. patent application Ser. No. 15/406,175 filed Jan. 13, 2017 and entitled “Apparatus and Methods for the Storage of Overlapping Regions of Imaging Data for the Generation of Optimized Stitched Images”, which is also incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE DISCLOSURE

### Field of the Disclosure

The present disclosure relates generally to image processing techniques and in one exemplary aspect, to methods and apparatus for in-loop padding for projection formats that include redundant data including, for example, Rotated Sphere Projections (RSP).

### Description of Related Art

Panoramic images (e.g., spherical images) are typically obtained by capturing multiple images with overlapping fields of view from different cameras and combining (“stitching”) these images together in order to provide, for example, a two-dimensional projection for use with modern display devices. Converting a panoramic image to a two-dimensional projection format can introduce some amount of distortion and/or affect the subsequent imaging data. However, two-dimensional projections are desirable for compatibility with existing image processing techniques and also for most user applications. In particular, many encoders and compression techniques assume traditional rectangular image formats.

Incipient interest into different projection formats has sparked research into a number of possible projection formats. Examples of prior art projection formats include without limitation e.g., equirectangular, cubemap, equal-area cubemap, octahedron, icosahedron, truncated square pyramid, and segmented sphere projection. For each of these projection formats, multiple facet (also called frame packing) arrangements are possible. A selection of prior art projections are described within e.g., “AHG8: Algorithm description of projection format conversion in 360Lib”, published Jan. 6, 2017, to the Joint Video Exploration Team (JVET) of ITU-T SG 16 WP 3 and ISO/IEC JTC 1/SC 29/WG 11, the contents of which being incorporated herein by reference in its entirety.

While techniques exist that enable the encoding/decoding of this so-called panoramic content, extant encoding (and decoding) techniques for these panoramic images may prove sub-optimal, especially in the context of pre-existing codecs. For example, the encoding/decoding of panoramic images using pre-existing codecs may result in, inter alia, increased processing overhead, lack of adequate bandwidth (bitrate) considerations, and decreased compression efficiencies.

### SUMMARY

The present disclosure satisfies the foregoing needs by providing, inter alia, methods and apparatus for providing in-loop padding for panoramic images that have redundant information contained therein in order to improve upon, inter alia, encoding compression efficiencies.

In one aspect, an encoder apparatus is disclosed. In one embodiment, the encoder apparatus is configured to obtain a frame of video data, the frame of video data including reduced quality areas within the frame of video data; transmit the obtained frame of the video data to a reconstruction engine; reconstruct the reduced quality areas to nearly original quality within the frame by use of other portions of the frame of video data in order to construct a high fidelity frame of video data; store the high fidelity frame of video data within a reference picture list; and use the high fidelity frame of video data stored within the reference picture list for encoding of subsequent frames of the video data.

In a second aspect, a decoder apparatus is disclosed. In one embodiment, the decoder apparatus is configured to receive an encoded frame of video data, the encoded frame of video data including a reduced quality version of a pre-encoded version of the frame of video data; retrieve one or more other frames of video data from a reference picture list, the one or more other frames of video data including nearly original quality versions of previously decoded frames; reconstruct the encoded received frame of video data to nearly original quality via use of the retrieved one or more other frames of video data; and store the reconstructed frame of video data to the reference picture list.

In a third aspect, a method for generating a high quality video frame for use in a reference picture list is disclosed. In one embodiment, the method includes obtaining a frame of video data, the frame of video data including high quality areas and reduced quality areas within the frame of video data; rotating a first high quality area of the high quality areas using a transform operation; translating the rotated first high quality area to a corresponding area within the reduced quality areas; wherein the translated and rotated first high quality area comprises redundant information with the first high quality area.

In a fourth aspect, a method for encoding imaging data is disclosed. In one embodiment, the encoded imaging data includes video data that includes a projection format that includes redundant data and the method further includes obtaining a frame of video data, the frame of video data including reduced quality areas within the frame of video data; transmitting the obtained frame of the video data to a reconstruction engine; reconstructing the reduced quality areas to nearly original quality within the frame by using other portions of the frame of video data in order to construct a high fidelity frame of video data; storing the high fidelity frame of video data within a reference picture list; and using the high fidelity frame of video data stored within the reference picture list for encoding of subsequent frames of the video data.

In one variant, the using of the other portions of the frame of video data includes using original quality areas within the frame of video data.

In another variant, the method further includes generating the reduced quality areas within the frame of video data, the generating further including rendering the reduced quality areas with inactive pixels.

In yet another variant, the method further includes generating the reduced quality areas within the frame of video data, the generating further including aggressively quantizing the reduced quality areas within the frame of video data.

In yet another variant, the reconstructing of the reduced quality areas to nearly original quality further includes: applying a geometric rotation to an area within the original quality areas within the frame of video data; and translating the geometrically rotated area to a reduced quality area within the reduced quality areas within the frame of video data.

In a fifth aspect, a method for decoding imaging data is disclosed. In one embodiment, the imaging data includes video data, the video data including a projection format that includes redundant data and the method includes receiving an encoded frame of video data, the encoded frame of video data including a reduced quality version of a pre-encoded version of the frame of video data; retrieving one or more other frames of video data from a reference picture list, the one or more other frames of video data including nearly original quality versions of previously decoded frames; reconstructing the encoded received frame of video data to nearly original quality using the retrieved one or more other frames of video data; and storing the reconstructed frame of video data to the reference picture list.

In one variant, the receiving of the encoded frame of video data includes receiving an encoded frame of video data according to a rotated sphere projection (RSP) projection format.

In another variant, the method further includes using the stored reconstructed frame of video data for the decoding of subsequent frames of encoded video data.

In yet another variant, the reconstructing of the encoded received frame of video data further includes: applying a geometric rotation to an area within the retrieved one or more other frames of video data; and translating the geometrically rotated area to a reduced quality area within the received encoded frame of video data.

In yet another variant, the method further includes using the stored reconstructed frame of video data for the decoding of subsequent frames of encoded video data.

In a sixth aspect, a computer-readable storage apparatus is disclosed. In one embodiment, the computer-readable storage apparatus includes a storage medium comprising computer-readable instructions, the computer-readable instructions being configured to, when executed by a processor apparatus: obtain a frame of video data, the frame of video data including reduced quality areas within the frame of video data; cause transmission of the obtained frame of the video data to a reconstruction engine; reconstruct the reduced quality areas to nearly original quality within the frame of video data via use of other portions of the frame of video data in order to construct a high fidelity frame of video data; store the high fidelity frame of video data within a reference picture list; and use the high fidelity frame of video data stored within the reference picture list for encode of subsequent frames of the video data.

In a seventh aspect, an integrated circuit (IC) apparatus is disclosed. In one embodiment, the IC apparatus is configured to obtain a frame of video data, the frame of video data including reduced quality areas within the frame of video data; cause transmission of the obtained frame of the video data to a reconstruction engine; reconstruct the reduced quality areas to nearly original quality within the frame of video data via use of other portions of the frame of video data in order to construct a high fidelity frame of video data; store the high fidelity frame of video data within a reference picture list; and use the high fidelity frame of video data stored within the reference picture list for encode of subsequent frames of the video data.

In an eighth aspect, a computing device is disclosed. In one embodiment, the computing device includes a signal generation device, the signal generation device configured to capture a plurality of frames of video data; a processing unit configured to process the plurality of frames of the video data; and a non-transitory computer-readable storage apparatus, the computer-readable storage apparatus including a storage medium having computer-readable instructions, the computer-readable instructions being configured to, when executed by the processing unit: obtain a frame of video data, the frame of video data including reduced quality areas within the frame of video data; cause transmission of the obtained frame of the video data to a reconstruction engine; reconstruct the reduced quality areas to nearly original quality within the frame of video data via use of other portions of the frame of video data in order to construct a high fidelity frame of video data; store the high fidelity frame of video data within a reference picture list; and use the high fidelity frame of video data stored within the reference picture list for encode of subsequent frames of the video data.

In one variant, the signal generation device is further configured to capture panoramic content, the captured panoramic content comprising a 360° field of view (FOV).

In another variant, the computing device includes additional computer-readable instructions, the additional computer-readable instructions being configured to, when executed by the processing unit: generate the frame of video data, the generated frame of video data comprising a rotated sphere projection (RSP) projection format.

In yet another variant, the computing device includes additional computer-readable instructions, the additional computer-readable instructions being configured to, when executed by the processing unit: generate the reduced quality areas within the RSP projection format, the generated reduced quality areas utilized to decrease a transmission bitrate for the captured plurality of frames of video data as compared with a transmission of the captured plurality of frames of video data without the reduced quality areas.

In yet another variant, the generation of the reduced quality areas within the RSP projection format includes a generation of inactive pixels for the reduced quality areas within the RSP projection format.

In yet another variant, the generation of the reduced quality areas within the RSP projection format includes an application of aggressive quantization for the reduced quality areas within the RSP projection format.

In yet another variant, the use of the other portions of the frame of video data includes a use of original quality areas within the frame of video data.

In yet another variant, the reconstruction of the reduced quality areas to nearly original quality further includes: application of a geometric rotation to an area within the original quality areas within the frame of video data; and translation of the geometrically rotated area to a reduced quality area within the reduced quality areas within the frame of video data.

In yet another variant, the computing device includes additional computer-readable instructions, the additional computer-readable instructions being configured to, when executed by the processing unit: receive an encoded frame of video data, the encoded frame of video data including a reduced quality version of a pre-encoded version of the frame of video data; retrieve one or more other frames of video data from a decoded picture buffer, the one or more other frames of video data including nearly original quality versions of previously decoded frames; reconstruct the encoded received frame of video data to nearly original quality using the retrieved one or more other frames of video data; and store the reconstructed frame of video data to the decoded picture buffer.

In yet another variant, the storage of the reconstructed frame of video data to the decoded picture buffer enables decode of subsequent encoded frames.

Other features and advantages of the present disclosure will immediately be recognized by persons of ordinary skill in the art with reference to the attached drawings and detailed description of exemplary implementations as given below.

### BRIEF DESCRIPTION OF THE DRAWINGS

FIG. 1 is a block diagram of an exemplary prior art hybrid video coding encoder apparatus.

FIG. 2 is a block diagram of an exemplary encoder apparatus with an RSP padding module, useful in describing the principles of the present disclosure.

FIG. 3A is a graphical representation of a first exemplary RSP frame with reduced quality areas, useful in describing the principles of the present disclosure.

FIG. 3B is a graphical representation of a second exemplary RSP frame with reduced quality areas, useful in describing the principles of the present disclosure.

FIG. 3C is a graphical representation of an exemplary high fidelity RSP frame, useful in describing the principles of the present disclosure.

FIG. 4 is a logical flow diagram illustrating an exemplary embodiment for the use of stored frames for the encoding of subsequent frame(s), useful in describing the principles of the present disclosure.

FIG. 5 is a logical flow diagram illustrating an exemplary embodiment for the storage of reconstructed frames in a reference picture list, useful in describing the principles of the present disclosure.

FIG. 6 is a logical flow diagram illustrating an exemplary embodiment for the storage of a high fidelity frame in a reference picture list, useful in describing the principles of the present disclosure.

FIG. 7A is a plot of coding gain without the use of a padding module as a function of a variety of input images in accordance with the principles of the present disclosure.

FIG. 7B is a plot of coding gain with the use of a padding module as a function of a variety of input images in accordance with the principles of the present disclosure.

FIG. 8 is a block diagram illustrating an exemplary encoder and decoder system, useful in describing the principles of the present disclosure.

FIG. 9 is a block diagram of an exemplary implementation of a computing device, useful in encoding and/or decoding image data, useful in describing the principles of the present disclosure.

All Figures disclosed herein are © Copyright 2017 GoPro, Inc. All rights reserved.

### DETAILED DESCRIPTION

Implementations of the present technology will now be described in detail with reference to the drawings, which are provided as illustrative examples and species of broader genus' so as to enable those skilled in the art to practice the technology. Notably, the figures and examples below are not meant to limit the scope of the present disclosure to any single implementation or implementations, but other implementations are possible by way of interchange of, substitution of, or combination with some or all of the described or illustrated elements. Wherever convenient, the same reference numbers will be used throughout the drawings to refer to same or like parts.

Moreover, while implementations described herein are primarily discussed in the context of so-called Rotated Sphere Projections (RSP) such as that described in co-owned and co-pending U.S. patent application Ser. No. 15/665,202 filed Jul. 31, 2017 and entitled “Methods and Apparatus for Providing a Frame Packing Arrangement for Panoramic Content”, which claims the benefit of priority to U.S. Provisional Patent Application Ser. No. 62/477,936 filed Mar. 28, 2017 of the same title; U.S. Provisional Patent Application Ser. No. 62/473,952 filed Mar. 20, 2017 of the same title; U.S. Provisional Patent Application Ser. No. 62/465,678 filed Mar. 1, 2017 of the same title; U.S. Provisional Patent Application Ser. No. 62/462,804 filed Feb. 23, 2017 of the same title; and U.S. Provisional Patent Application Ser. No. 62/446,297 filed Jan. 13, 2017 and entitled “Methods and Apparatus for Rotated Sphere Projections”, the contents of each of the foregoing incorporated supra, it is readily appreciated that the principles described herein can be equally applied to other projection formats that contain, inter alia, redundant information within, for example, frames of imaging data.

These and other variations would be readily apparent to one of ordinary skill given the contents of the present disclosure.

Exemplary in-Loop Padding for Projections with Redundant Information—

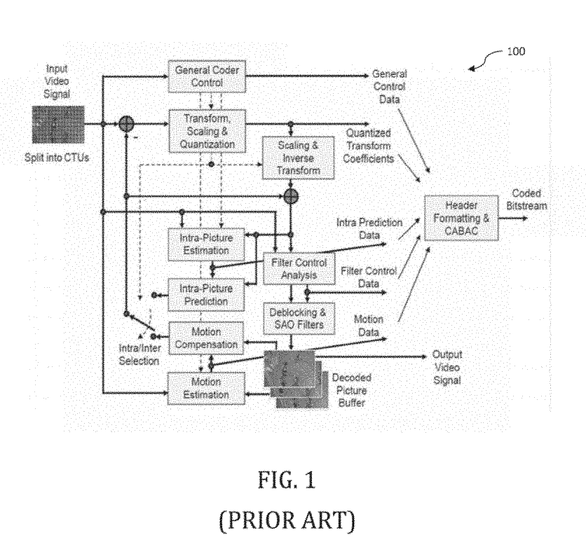

FIG. 1 is a block diagram of a typical Hybrid video encoding engine 100. This encoding engine 100 may include some of the functional building blocks from any one of a number of standard codecs including, for example, H.264, High Efficiency Video Coding (HEVC), VP9, and/or AV1 codecs. An input imaging signal (e.g., video signal) may be input into the encoding engine for encoding. This input imaging signal may include, for example, an input macroblock or coding unit (CU). The input imaging signal to be encoded is subtracted from a previously encoded imaging signal (e.g., a macroblock or CU), resulting in a residual signal. This residual signal may then be transformed, quantized, and entropy coded prior to being transmitted to, for example, a decoder. The encoding engine 100 may reconstruct the same block, in the same manner as would take place at a decoder, in order to encode input imaging signals. Accordingly, the encoding engine 100 may perform scaling and inverse transforms, and afterwards use a predicted block in order to construct a reconstructed imaging signal (e.g., a block or picture). This reconstructed imaging signal may then be processed using an in-loop filter, which may include a deblocking filter, a sample additive offset (SAO) functional block and/or an adaptive loop filter (ALF). Subsequently, this processed reconstructed imaging signal may be placed into a decoded picture buffer (e.g., a reference picture list). Future imaging signals to be encoded may then use these imaging signals that are stored within the decoded picture buffer for the purpose of motion compensation, motion estimation, intra-picture estimation and/or intra-picture prediction.

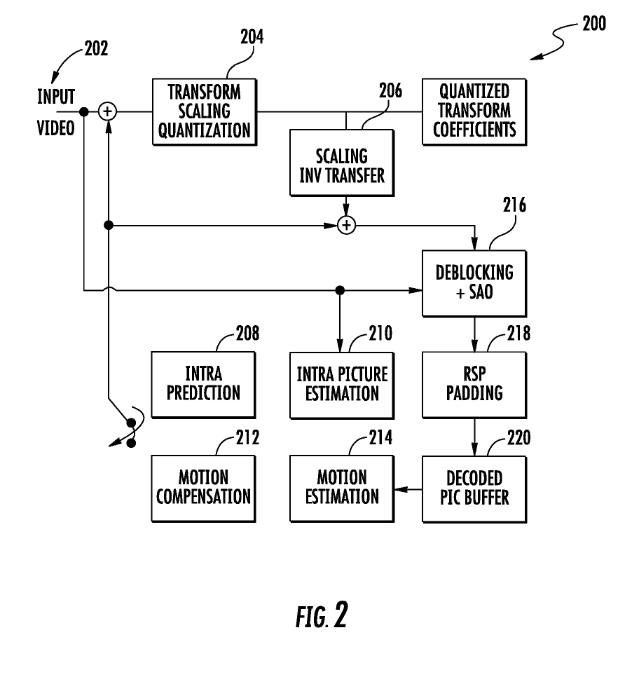

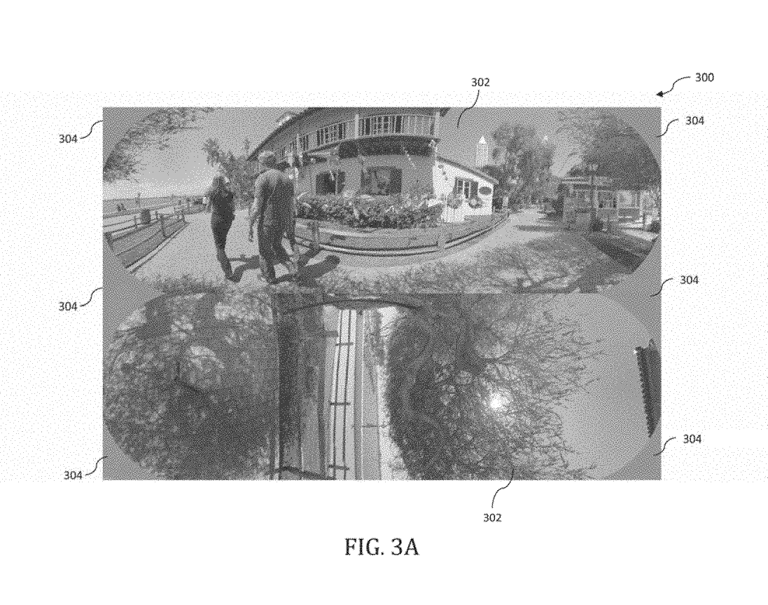

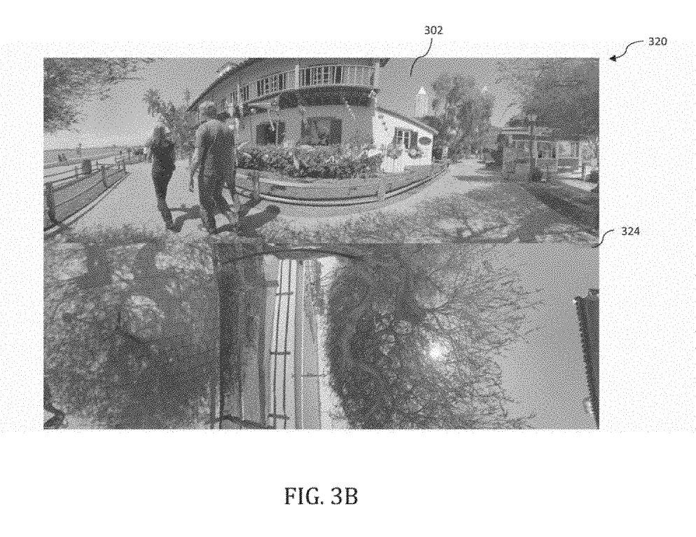

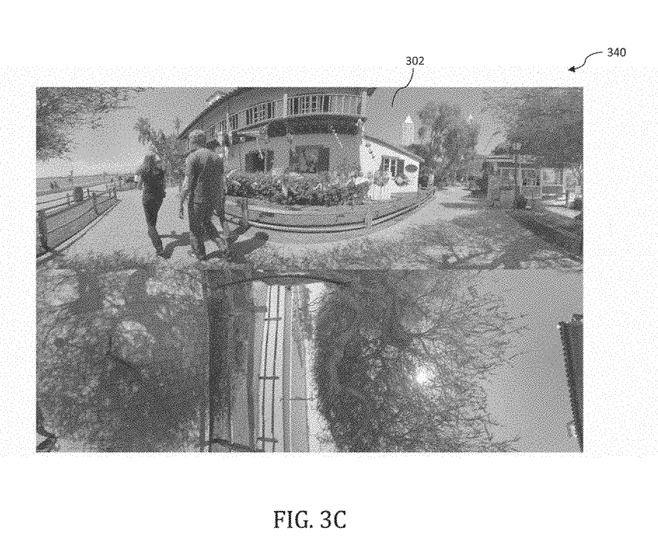

FIG. 2 is a block diagram of an exemplary encoding engine 200 for use in accordance with the principles of the present disclosure. Similar to the encoding engine 100 of FIG. 1, the encoding engine 200 takes as input an imaging signal 202 (e.g., a video signal). The encoding engine 200 also includes a transform, scaling and quantization module 204, a scaling and inverse transform module 206, a deblocking and SAO module 216, a decoded picture buffer 220, an intra-picture prediction module 208, an intra-picture estimation module 210, a motion compensation module 212, and a motion estimation module 214. However, unlike the encoding engine illustrated in FIG. 1, the encoding engine 200 of FIG. 2 includes a so-called in-loop padding module 218 (e.g., for use with RSP projections such as those disclosed in co-owned and co-pending U.S. patent application Ser. No. 15/665,202 filed Jul. 31, 2017 and entitled “Methods and Apparatus for Providing a Frame Packing Arrangement for Panoramic Content”, the contents of which were incorporated herein supra). The function of the padding module 218 will be discussed in subsequent detail with reference to FIGS. 3A-3C.

FIG. 3A illustrates an exemplary RSP frame 300 that includes a top facet that includes, for example, left, front, and right images from a panoramic (e.g., a 360° field of view (FOV)) image capture device. The bottom facet includes, for example, bottom, back, and top images from the panoramic image capture device. While the aforementioned left, front, and right images for the top imaging facet and bottom, back, and top images for the bottom imaging facet are exemplary, it would be readily apparent to one of ordinary skill that the arrangement of these directional views may be varied in certain implementations. As discussed in co-owned and co-pending U.S. patent application Ser. No. 15/665,202 filed Jul. 31, 2017 and entitled “Methods and Apparatus for Providing a Frame Packing Arrangement for Panoramic Content”, the contents of which were incorporated herein supra, portions of the RSP frame 300 may be rendered as reduced quality areas 304 as well as original quality areas 302. As used herein, the term “reduced quality areas” refers to the fact that redundant information exist in other portions of the image or frame and hence, these areas may be strategically reduced in image quality in order to realize, inter alia, bitrate savings during transmission of these projection formats.

In the illustrated embodiment of FIG. 3A, these reduced quality areas 304 include inactive pixels (e.g., greyed out pixels). As previously alluded to, the reduced quality areas 304 are designated as such due to the fact that the imaging information contained within these areas is redundantly contained in other portions of the RSP frame 300, albeit in a rotated fashion. For example, in the upper left hand corner of the frame, it can be seen that the reduced quality area 304 in this corner would include portions of a tree. However, it can be also be seen that this tree, and specifically the area of this tree that can't be seen in the reduced quality area 304 in the upper left hand corner, is included towards the right center of the bottom facet image. These inactive pixels (e.g., greyed out pixels) are easier to code than active pixels, and hence may result in bitrate savings when transmitting this RSP frame 300 to, for example, a decoder. In other words, by taking these redundant areas 304 of information and rendering these pixels as, for example, inactive, desirable bit rate savings are achieved.

FIG. 3B illustrates an alternative RSP frame 320 to that depicted in FIG. 3A. In this illustrated example, the reduced quality areas have been aggressively quantized (as opposed to being rendered inactive as shown in FIG. 3A). As used herein, the term “aggressively quantized” refers to the fact that these reduced quality areas may have a higher quantization parameter (QP) value than other areas of the image. As but yet another example implementation, one may change the lambda parameter in addition to, or alternatively than, the application of aggressive quantization. In other words, an encoder may be tuned to have the same QP throughout the picture, but may spend less bits in these so-called reduced quality areas. These aggressively quantized areas 324 result in bitrate savings during, for example, transmission as well. However, aggressively quantizing these redundant information areas may be easier to implement than rendering these redundant information areas as inactive. The reasoning for this relative ease for implementation is due to the fact that typical encoders have QP control available and are configurable per coding unit (e.g., encodable per a given area of the image). Additionally, RSP frame 320 with aggressively quantized areas may result in better seam artifacts during decoding and rendering processes due to the fact that the encoder has the opportunity to “see” both sides of the boundary area between the original quality image 302 and the reduced quality areas 324. The reduced quality areas 324 that are aggressively quantized are in the same positions as the inactive pixel areas 304 illustrated in FIG. 3A.

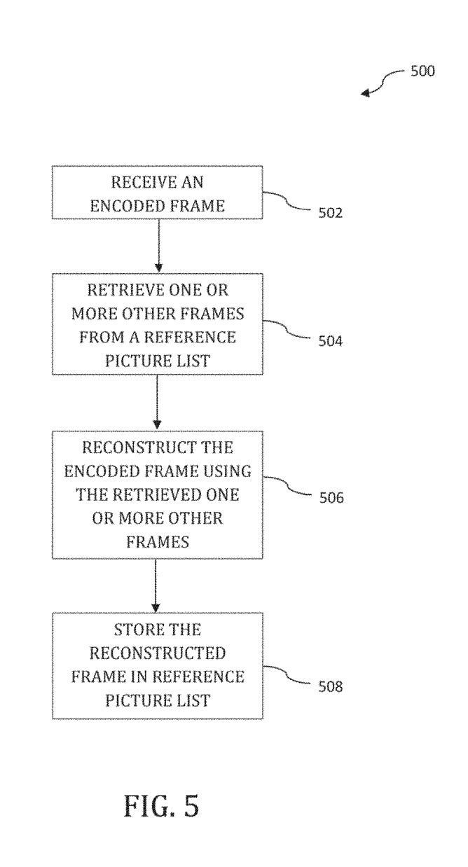

As a brief aside, the positioning of these reduced quality areas 304, 324 within FIGS. 3A and 3B may not be exclusively positioned at the corners of the RSP frames 300, 320. In fact, other areas within the RSP frames 300, 320 may be rendered as reduced quality areas in other implementations such as those shown in co-owned and co-pending U.S. patent application Ser. No. 15/665,202 filed Jul. 31, 2017 and entitled “Methods and Apparatus for Providing a Frame Packing Arrangement for Panoramic Content”, the contents of which were incorporated herein supra. See also, for example, FIGS. 5H, 5I, 5J in U.S. patent application Ser. No. 15/665,202. In fact, any area in which redundant information is contained elsewhere in the frame, may be used for the purpose of selecting reduced quality areas in other implementations.

Using a conventional encoding engine (such as the encoding engine 100 depicted in FIG. 1) for the encoding of RSP frames 300, 320 will result in these frames getting stored in the decoded picture buffer (e.g., reference picture list) for the encoding of subsequent frames. As a result of inclusion of reduced quality areas in order to reduce, for example, transmission bitrate, the use of these RSP frames 300, 320 using encoding engine 100 may result in inefficient prediction for future frames. However, since the pixels contained within these reduced quality areas are available in other portions of the frame (i.e., are redundant), these pixels may be reconstructed using, for example, the padding module 218 in FIG. 2 prior to being stored in the decoded picture buffer 220. In other words, the padding module 218 may be able to transform these reduced quality areas into higher fidelity pixels (i.e., higher quality reproductions than that contained in, for example, projection formats with reduced quality areas).

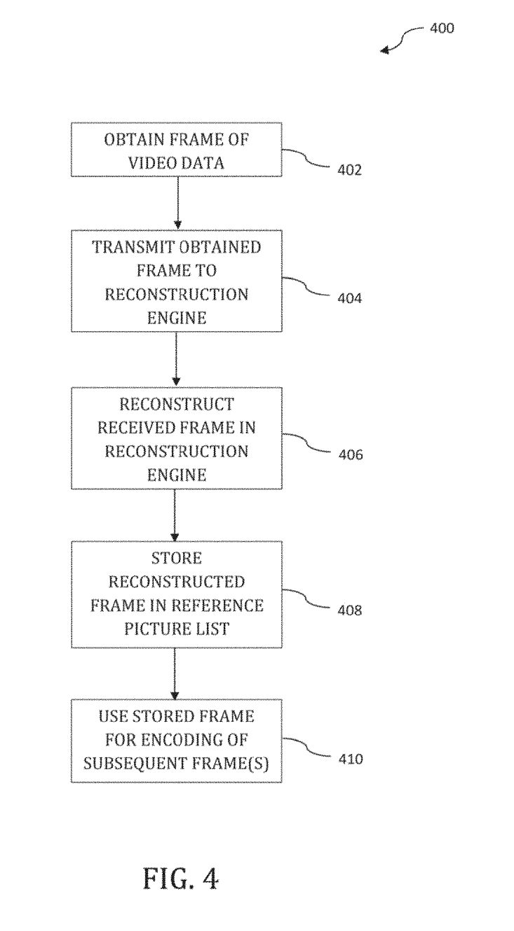

By transforming these reduced quality areas into higher fidelity pixels (e.g., closer to the uncompressed input frame), the output of the encoding engine 200 may be improved resulting in improved compression efficiencies during the encoding process. Moreover, using the padding module 218 may allow the encoder to see, for example, an object coming into the RSP frame from one of these boundary areas, thereby improving upon motion estimation performance. The padding module 218 may fill in these reduced quality areas by performing a spherical rotation and, for example, an interpolation on pixels from other portions of the RSP frame. FIG. 3C illustrates one exemplary output RSP frame 340 from the padding module 218 for storage in the decoded picture buffer 220 in which the reduced quality areas have been replaced with higher fidelity imaging areas as will be described subsequently herein with reference to FIGS. 4-6.

Referring now to FIG. 4, an exemplary embodiment for the use of stored frames for the encoding of subsequent frame(s) 400 is shown and described in detail. At operation 402, a frame of imaging data is obtained. This frame of imaging data may be indicative of a statically captured scene, or alternatively may be indicative of a frame of a video sequence. In some implementations, this frame of imaging data is obtained directly from the imaging sensors of an image capture device (e.g., an image capture device that is capable of obtaining images with a 360° (or near 360°) FOV). Alternatively, this frame of imaging data may be obtained from a computer-readable apparatus (e.g., a hard drive and/or other types of memory capable of storing imaging data). This obtained frame of imaging data may include areas of reduced quality (e.g., inactive pixels as shown in FIG. 3A or heavily quantized areas as shown in FIG. 3B) as well as areas of original (or near original) quality. These areas of reduced quality may be representative of redundant imaging information, this redundant imaging information being contained within other areas (e.g., in original quality areas) of the obtained frame of imaging data.

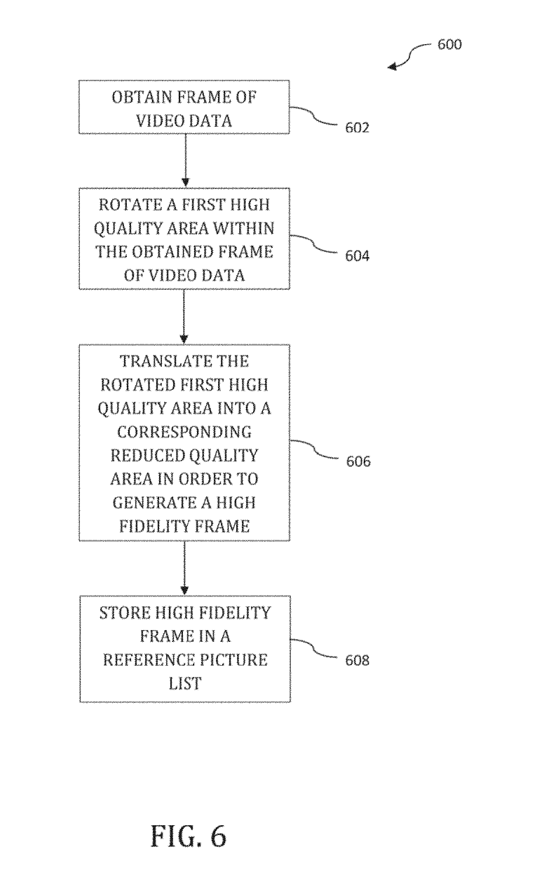

At operation 404, the obtained frame of video data from operation 402 is transmitted to, and received at, a reconstruction engine. In some implementations, the reconstruction engine may include, for example, the padding module 218 of FIG. 2. At operation 406, the obtained frame of imaging data may be reconstructed in the reconstruction engine. In other words, and in some implementations, the reconstruction engine may be configured to process original quality areas of the obtained frame of imaging data, perform a geometric rotation of these original quality areas, and translate this geometrically rotated imaging data into the reduced quality areas. The result of this reconstruction process may result in a higher fidelity frame being constructed. Implementations of this reconstruction will be described in additional detail with respect to FIG. 6 described subsequently herein.

At operation 408, the reconstructed frame of imaging data resultant from operation 406 is stored in a reference picture list (e.g., a decoded picture buffer), while at operation 410, the stored frame of imaging data in the reference picture list is used for the encoding of subsequent frame(s) of imaging data. The result of the methodology 400 of FIG. 4 is that the transmission of encoded frames of imaging data (such as the aforementioned RSP imaging data) may include reduced quality areas, such as the inactive pixel regions of FIG. 3A or the aggressively quantized regions of FIG. 3B. The transmission of this frame of imaging data with reduced quality areas results in bitrate savings as described elsewhere herein.

However, this frame of imaging data with reduced quality areas may result in inefficient prediction for future frames of imaging data. Accordingly, it may be advantageous to store higher fidelity images in the reference picture list (e.g., a decoded picture buffer) in order to improve upon, inter alia, motion estimation performance for the encoding of subsequent frames of imaging data. In other words, the reconstruction of these reduced quality areas into higher fidelity areas may improve upon encoding performance as the higher fidelity pixel areas may be closer to an uncompressed input picture. Additionally, this reconstruction may also allow an encoder to see an object coming into, for example, an RSP frame (i.e., into a seam area of the RSP frame or an RSP imaging facet), thereby improving upon motion estimation performance during the encoding process resulting in improved compression efficiencies for the encoding process. Moreover, as these higher fidelity images are not transmitted to, for example, a decoder, the bitrate savings achieved by introducing reduced quality areas may not be severely impacted. In other words, these higher fidelity images may be stored in, for example, an encoder.

While FIG. 4 illustrates an exemplary methodology for use with the encoding process, FIG. 5 illustrates an exemplary methodology as it applies to the decoding process. Specifically, FIG. 5 illustrates an exemplary methodology 500 for the storing of reconstructed frame(s) in a reference picture list (e.g., a decoded picture buffer). At operation 502, an encoded frame of imaging data is received at, for example, a decoder. This encoded frame of imaging data may include, for example, an exemplary RSP frame with reduced quality areas (e.g., inactive pixels as shown in FIG. 3A or heavily quantized areas as shown in FIG. 3B as but exemplary implementations). In some implementations, the received encoded frame may include reduced quality areas in which redundant information for these reduced quality areas is contained in other portions of the frame (e.g., within original quality areas for example).

At operation 504, one or more other frames are retrieved from a reference picture list. In some implementations, these one or more other frames may be temporally proximate to the received encoded frame (e.g., consisting of the prior two frames from a video sequence as but one non-limiting example). At operation 506, the received encoded frame is reconstructed using the retrieved one or more other frames. In some implementations, the reconstruction process may utilize portions of the received encoded frame itself in addition to, or alternatively than, using the retrieved one or more other frames. This reconstruction may include a geometric rotation of these original quality areas within the received encoded frame (and/or a geometric rotation from the retrieved one or more other frames from the reference picture list), and translation of this geometrically rotated imaging data into the reduced quality areas of the received encoded frame. At operation 508, this reconstructed frame of imaging data may be stored in a reference picture list (e.g., a decoded picture buffer) for use in, for example, the decoding of subsequent frames of imaging data.

Referring now to FIG. 6, an exemplary methodology 600 for the storage of a high fidelity frame in a reference picture list (e.g., a decoded picture buffer) is shown and described in detail. At operation 602, a frame of imaging data is obtained. Similar to the discussion with respect to FIG. 4 described supra, this frame of imaging data may be indicative of a statically captured scene, or alternatively may be indicative of a frame of a video sequence. In some implementations, this frame of imaging data is obtained directly from the imaging sensors of an image capture device (e.g., an image capture device that is capable of obtaining images with a 360° (or near 360°) FOV). Alternatively, this frame of imaging data may be obtained from a computer-readable apparatus (e.g., a hard drive and/or other types of memory capable of storing imaging data). This obtained frame of imaging data may include areas of reduced quality (e.g., inactive pixels as shown in FIG. 3A or heavily quantized areas as shown in FIG. 3B) as well as areas of original quality. These areas of reduced quality may be representative of redundant imaging information, this redundant imaging information being contained within other areas (e.g., original quality areas) of the obtained frame of imaging data.

At operation 604, a first high quality area (e.g., an original quality area) within the obtained frame of imaging data is geometrically rotated. This first high quality area corresponds to redundant information present within the reduced quality areas of the frame of imaging data. In some implementations, this first high quality area may consist of one or more pixels (e.g., a single CU within the frame). The mathematical equations, along with their accompanying description for performing this rotation with respect to RSP imaging data, are contained within Appendix I. Similar mathematical relationships would be readily apparent to one of ordinary skill given the contents of the present disclosure for other projection formats and/or projection format variations.

At operation 606, the rotated first high quality area is translated into a corresponding reduced quality area in order to generate a high fidelity frame. In other words, the reduced quality areas of the frame may be replaced with original quality (or near original quality) pixels. As discussed elsewhere herein, the reduced quality areas comprise redundant information for the frame of imaging data and hence the rotation operation 604 and translation operation 606 may be performed for these reduced quality areas in order to generate a high fidelity frame of imaging data. At operation 608, the high fidelity frame is stored in a reference picture list (e.g., a decoded picture buffer). The frame(s) stored in the reference picture list may then be used for the encoding of subsequent frame(s).

Coding Performance for in-Loop Padding Module

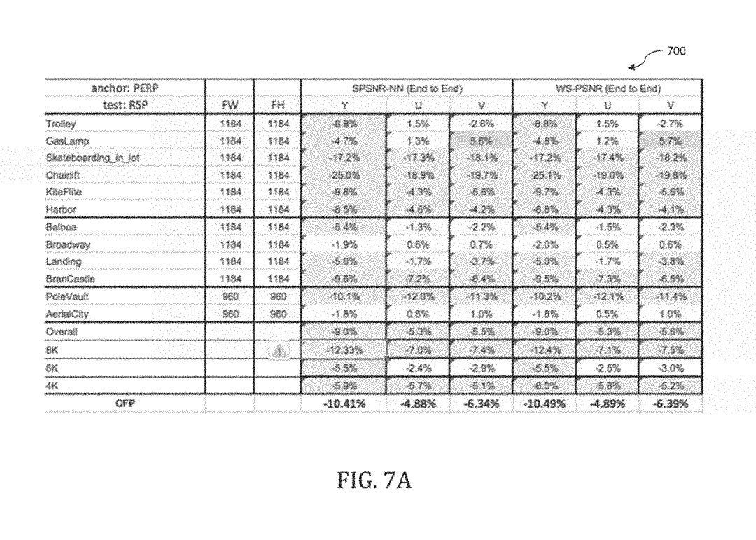

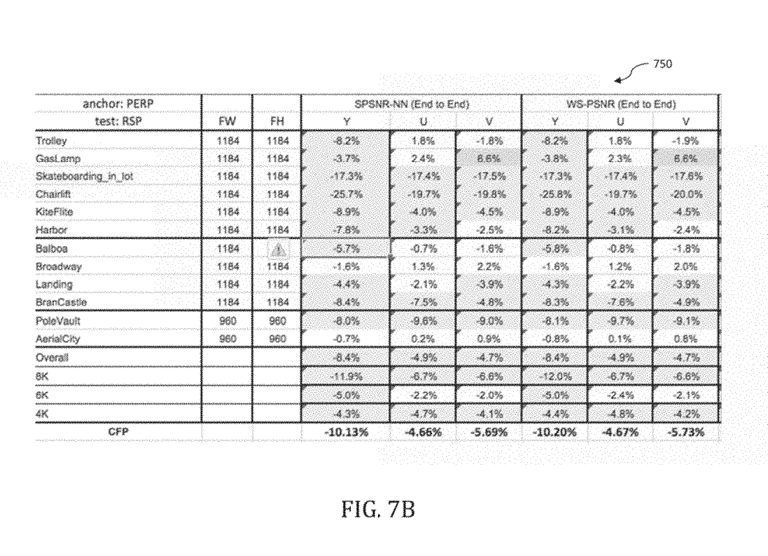

Referring now to FIGS. 7A and 7B, coding gain results are illustrated as a function of different input images. Specifically, FIG. 7A illustrates coding gain results 700 using an encoder without the use of padding module 218 illustrated in FIG. 2 as a function of various input images. These input images include, for example, an image of a trolley, an image of the Gaslamp District, an image of a skateboarder in a parking lot, an image of a chairlift, an image of a kite in flight, an image of a harbor, an image of Balboa Park, an image of Broadway, an image of a landing, an image of Bran Castle, an image of a pole-vaulter, an image of an aerial city, as well as a variety of image resolutions (e.g., 4K images, 6K images, 8K images). Similarly, FIG. 7B illustrates coding gain results 750 using an encoder as a function of various input images (i.e., the same input images as is depicted in FIG. 7A). However, unlike the coding gain results 700 illustrated in FIG. 7A, the coding gain results 750 of FIG. 7B utilizes an encoder with a padding module (such as RSP padding module 218 depicted in FIG. 2). As can be seen from the coding results 750 depicted in FIG. 7B, the use of a padding module improves upon the coding gain for the encoding of various images. Additionally, the use of a padding module within an encoder works well for moving camera content such as, for example, the chairlift image and the Balboa Park image.

### Exemplary Apparatus—

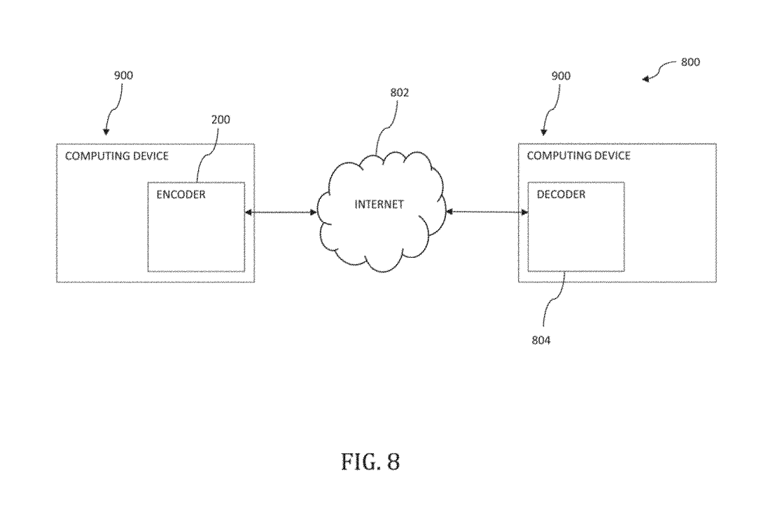

FIG. 8 is a block diagram illustrating an exemplary system 800 for the encoding/decoding of imaging data in accordance with, for example, the methodologies described with respect to FIGS. 3A-6. In the illustrated example embodiment, two computing devices 900 are shown as being communicatively coupled via, for example, the Internet 802. However, the usage of the Internet 802 should be merely considered exemplary as other implementations may communicatively couple the encoder 200 and the decoder 804 by means of other known communication mechanisms. Moreover, while one computing device 900 is shown as including an encoder 200, while the other computing device 900 is shown as including a decoder 804, it would be readily apparent to one of ordinary skill given the contents of the present disclosure that the encoder/decoders shown respectively may be essentially identical in some implementations. In other words, the encoder 200 may include in certain circumstances the ability to decode images received. Additionally, the decoder 804 may include in certain circumstances the ability to encode images to be transmitted.

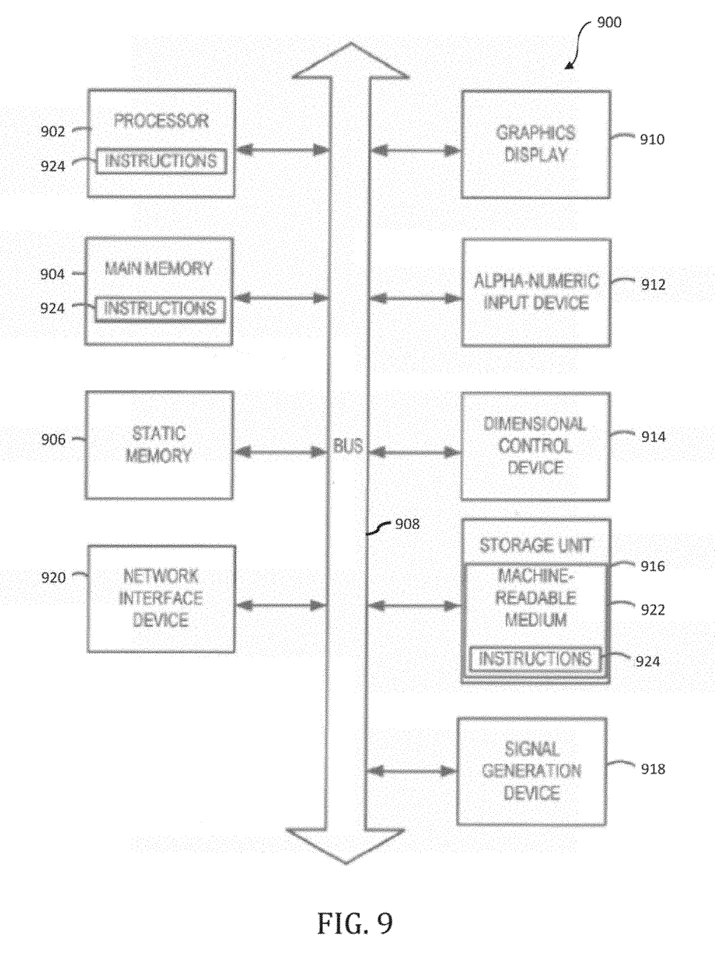

FIG. 9 is a block diagram illustrating components of an example computing system 900 able to read instructions from a computer-readable medium and execute them in one or more processors (or controllers). The computing system in FIG. 9 may represent an implementation of, for example, an image/video processing device for encoding and/or decoding of a projection that includes redundant information as discussed with respect to, for example, FIGS. 2-8.

The computing system 900 can be used to execute instructions 924 (e.g., program code or software) for causing the computing system 900 to perform any one or more of the encoding/decoding methodologies (or processes) described herein. In alternative embodiments, the computing system 900 operates as a standalone device or a connected (e.g., networked) device that connects to other computer systems. The computing system 900 may include, for example, an action camera (e.g., a camera capable of capturing, for example, a 360° FOV), a personal computer (PC), a tablet PC, a notebook computer, or other device capable of executing instructions 924 (sequential or otherwise) that specify actions to be taken. In another embodiment, the computing system 900 may include a server. In a networked deployment, the computing system 900 may operate in the capacity of a server or client in a server-client network environment, or as a peer device in a peer-to-peer (or distributed) network environment. Further, while only a single computer system 900 is illustrated, a plurality of computing systems 900 may operate to jointly execute instructions 924 to perform any one or more of the encoding/decoding methodologies discussed herein.

The example computing system 900 includes one or more processing units (generally processor apparatus 902). The processor apparatus 902 may include, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of the foregoing. The computing system 900 may include a main memory 904. The computing system 900 may include a storage unit 916. The processor 902, memory 904 and the storage unit 916 may communicate via a bus 908.

In addition, the computing system 900 may include a static memory 906, a display driver 910 (e.g., to drive a plasma display panel (PDP), a liquid crystal display (LCD), a projector, or other types of displays). The computing system 900 may also include input/output devices, e.g., an alphanumeric input device 912 (e.g., touch screen-based keypad or an external input device such as a keyboard), a dimensional (e.g., 2-D or 3-D) control device 914 (e.g., a touch screen or external input device such as a mouse, a trackball, a joystick, a motion sensor, or other pointing instrument), a signal capture/generation device 918 (e.g., a speaker, camera, and/or microphone), and a network interface device 920, which also are configured to communicate via the bus 908.

Embodiments of the computing system 900 corresponding to a client device may include a different configuration than an embodiment of the computing system 900 corresponding to a server. For example, an embodiment corresponding to a server may include a larger storage unit 916, more memory 904, and a faster processor 902 but may lack the display driver 910, input device 912, and dimensional control device 914. An embodiment corresponding to an action camera may include a smaller storage unit 916, less memory 904, and a power efficient (and slower) processor 902 and may include multiple image capture devices 918 (e.g., to capture 360° FOV images or video).

The storage unit 916 includes a computer-readable medium 922 on which is stored instructions 924 (e.g., a computer program or software) embodying any one or more of the methodologies or functions described herein. The instructions 924 may also reside, completely or at least partially, within the main memory 904 or within the processor 902 (e.g., within a processor's cache memory) during execution thereof by the computing system 900, the main memory 904 and the processor 902 also constituting computer-readable media. The instructions 924 may be transmitted or received over a network via the network interface device 920.

While computer-readable medium 922 is shown in an example embodiment to be a single medium, the term “computer-readable medium” should be taken to include a single medium or multiple media (e.g., a centralized or distributed database, or associated caches and servers) able to store the instructions 924. The term “computer-readable medium” shall also be taken to include any medium that is capable of storing instructions 924 for execution by the computing system 900 and that cause the computing system 900 to perform, for example, one or more of the methodologies disclosed herein.

Where certain elements of these implementations can be partially or fully implemented using known components, only those portions of such known components that are necessary for an understanding of the present disclosure are described, and detailed descriptions of other portions of such known components are omitted so as not to obscure the disclosure.

In the present specification, an implementation showing a singular component should not be considered limiting; rather, the disclosure is intended to encompass other implementations including a plurality of the same component, and vice-versa, unless explicitly stated otherwise herein.

Further, the present disclosure encompasses present and future known equivalents to the components referred to herein by way of illustration.

As used herein, the term “computing device”, includes, but is not limited to, personal computers (PCs) and minicomputers, whether desktop, laptop, or otherwise, mainframe computers, workstations, servers, personal digital assistants (PDAs), handheld computers, embedded computers, programmable logic device, personal communicators, tablet computers, portable navigation aids, J2ME equipped devices, cellular telephones, smart phones, personal integrated communication or entertainment devices, or literally any other device capable of executing a set of instructions.

As used herein, the term “computer program” or “software” is meant to include any sequence or human or machine cognizable steps which perform a function. Such program may be rendered in virtually any programming language or environment including, for example, C/C++, C#, Fortran, COBOL, MATLAB™, PASCAL, Python, assembly language, markup languages (e.g., HTML, SGML, XML, VoXML), and the like, as well as object-oriented environments such as the Common Object Request Broker Architecture (CORBA), Java™ (including J2ME, Java Beans), Binary Runtime Environment (e.g., BREW), and the like.

As used herein, the terms “integrated circuit”, is meant to refer to an electronic circuit manufactured by the patterned diffusion of trace elements into the surface of a thin substrate of semiconductor material. By way of non-limiting example, integrated circuits may include field programmable gate arrays (e.g., FPGAs), a programmable logic device (PLD), reconfigurable computer fabrics (RCFs), systems on a chip (SoC), application-specific integrated circuits (ASICs), and/or other types of integrated circuits.

As used herein, the term “memory” includes any type of integrated circuit or other storage device adapted for storing digital data including, without limitation, ROM. PROM, EEPROM, DRAM, Mobile DRAM, SDRAM, DDR/2 SDRAM, EDO/FPMS, RLDRAM, SRAM, “flash” memory (e.g., NAND/NOR), memristor memory, and PSRAM.

As used herein, the term “processing unit” is meant generally to include digital processing devices. By way of non-limiting example, digital processing devices may include one or more of digital signal processors (DSPs), reduced instruction set computers (RISC), general-purpose (CISC) processors, microprocessors, gate arrays (e.g., field programmable gate arrays (FPGAs)), PLDs, reconfigurable computer fabrics (RCFs), array processors, secure microprocessors, application-specific integrated circuits (ASICs), and/or other digital processing devices. Such digital processors may be contained on a single unitary IC die, or distributed across multiple components.

As used herein, the term “camera” may be used to refer without limitation to any imaging device or sensor configured to capture, record, and/or convey still and/or video imagery, which may be sensitive to visible parts of the electromagnetic spectrum and/or invisible parts of the electromagnetic spectrum (e.g., infrared, ultraviolet), and/or other energy (e.g., pressure waves).

It will be recognized that while certain aspects of the technology are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

While the above detailed description has shown, described, and pointed out novel features of the disclosure as applied to various implementations, it will be understood that various omissions, substitutions, and changes in the form and details of the device or process illustrated may be made by those skilled in the art without departing from the disclosure. The foregoing description is of the best mode presently contemplated of carrying out the principles of the disclosure. This description is in no way meant to be limiting, but rather should be taken as illustrative of the general principles of the technology. The scope of the disclosure should be determined with reference to the claims.

What is claimed:

1. A method for encoding video data, the video data comprising a projection format that includes redundant data, the method comprising:
obtaining a frame of video data, the frame of video data comprising reduced quality areas within the frame of video data;
transmitting the obtained frame of the video data to a reconstruction engine;
reconstructing the reduced quality areas to nearly original quality within the frame by using other portions of the frame of video data in order to construct a high fidelity frame of video data;
storing the high fidelity frame of video data within a reference picture list; and
using the high fidelity frame of video data stored within the reference picture list for encoding of subsequent frames of the video data.

2. The method of claim 1, wherein the using of the other portions of the frame of video data comprises using original quality areas within the frame of video data.

3. The method of claim 2, further comprising generating the reduced quality areas within the frame of video data, the generating further comprising rendering the reduced quality areas with inactive pixels.

4. The method of claim 2, further comprising generating the reduced quality areas within the frame of video data, the generating further comprising aggressively quantizing the reduced quality areas within the frame of video data.

5. The method of claim 2, wherein the reconstructing of the reduced quality areas to nearly original quality further comprises:
applying a geometric rotation to an area within the original quality areas within the frame of video data; and
translating the geometrically rotated area to a reduced quality area within the reduced quality areas within the frame of video data.

6. A computing device, the computing device comprising:
a signal generation device, the signal generation device configured to capture a plurality of frames of video data;
a processing unit configured to process the plurality of frames of the video data; and
a non-transitory computer-readable storage apparatus, the computer-readable storage apparatus comprising a storage medium comprising computer-readable instructions, the computer-readable instructions being configured to, when executed by the processing unit:
obtain a frame of video data, the frame of video data comprising reduced quality areas within the frame of video data;
cause transmission of the obtained frame of the video data to a reconstruction engine;
reconstruct the reduced quality areas to nearly original quality within the frame of video data via use of other portions of the frame of video data in order to construct a high fidelity frame of video data;
store the high fidelity frame of video data within a reference picture list; and
use the high fidelity frame of video data stored within the reference picture list for encode of subsequent frames of the video data.

7. The computing device of claim 6, wherein the signal generation device is further configured to capture panoramic content, the captured panoramic content comprising a 360° field of view (FOV).

8. The computing device of claim 7, further comprising additional computer-readable instructions, the additional computer-readable instructions being configured to, when executed by the processing unit:
generate the frame of video data, the generated frame of video data comprising a rotated sphere projection (RSP) projection format.

9. The computing device of claim 8, further comprising additional computer-readable instructions, the additional computer-readable instructions being configured to, when executed by the processing unit:
generate the reduced quality areas within the RSP projection format, the generated reduced quality areas utilized to decrease a transmission bitrate for the captured plurality of frames of video data as compared with a transmission of the captured plurality of frames of video data without the reduced quality areas.

10. The computing device of claim 9, wherein the generation of the reduced quality areas within the RSP projection format comprises a generation of inactive pixels for the reduced quality areas within the RSP projection format.

11. The computing device of claim 9, wherein the generation of the reduced quality areas within the RSP projection format comprises an application of aggressive quantization for the reduced quality areas within the RSP projection format.

12. The computing device of claim 6, wherein the use of the other portions of the frame of video data comprises a use of original quality areas within the frame of video data.

13. The computing device of claim 12, wherein the reconstruction of the reduced quality areas to nearly original quality further comprises:
application of a geometric rotation to an area within the original quality areas within the frame of video data; and
translation of the geometrically rotated area to a reduced quality area within the reduced quality areas within the frame of video data.

14. The computing device of claim 6, further comprising additional computer-readable instructions, the additional computer-readable instructions being configured to, when executed by the processing unit:
receive an encoded frame of video data, the encoded frame of video data comprising a reduced quality version of a pre-encoded version of the frame of video data;
retrieve one or more other frames of video data from a decoded picture buffer, the one or more other frames of video data comprising nearly original quality versions of previously decoded frames;
reconstruct the encoded received frame of video data to nearly original quality using the retrieved one or more other frames of video data; and
store the reconstructed frame of video data to the decoded picture buffer.

15. The computing device of claim 14, wherein the storage of the reconstructed frame of video data to the decoded picture buffer enables decode of subsequent encoded frames.

16. A method for decoding video data, the video data comprising a projection format that includes redundant data, the method comprising:
receiving an encoded frame of video data, the encoded frame of video data comprising a reduced quality version of a pre-encoded version of the frame of video data;
retrieving one or more other frames of video data from a reference picture list, the one or more other frames of video data comprising nearly original quality versions of previously decoded frames;
reconstructing the encoded received frame of video data to nearly original quality using the retrieved one or more other frames of video data; and
storing the reconstructed frame of video data to the reference picture list.

17. The method of claim 16, wherein the receiving of the encoded frame of video data comprises receiving an encoded frame of video data according to a rotated sphere projection (RSP) projection format.

18. The method of claim 17, further comprising using the stored reconstructed frame of video data for the decoding of subsequent frames of encoded video data.

19. The method of claim 16, wherein the reconstructing of the encoded received frame of video data further comprises:
applying a geometric rotation to an area within the retrieved one or more other frames of video data; and
translating the geometrically rotated area to a reduced quality area within the received encoded frame of video data.

20. The method of claim 19, further comprising using the stored reconstructed frame of video data for the decoding of subsequent frames of encoded video data.
